(19) United States
(12) Patent Application Publication
(10) Pub. No.: US 2006/0140433 A1
(43) Pub. Date: Jun. 29, 2006

(54) Dual sided ear cup

(75) Inventors: Julio C. Castaneda, Coral Springs, FL (US); Glenn R. Nelson, Boynton Beach, FL (US); Anabel M. Nogueiras, Miramar, FL (US); Eric S. Penrod, Sunrise, FL (US); Francis M. Staszesky, Fort Lauderdale, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: Motorola, Inc., Schaumberg, IL (US)

(21) Appl. No.: 11/027,738

(22) Filed: Dec. 29, 2004

(51) Int. Cl. H04R 25/00

(52) U.S. Cl. 381/372; 381/371

(57) ABSTRACT

The present embodiments provide dual sided ear cup systems (620) operable with devices, such as a communication device (120). The dual sided ear cup system includes a transducer (622) that generates acoustical signals from both a front side (624) and a back side (626). The system preferably further includes a front side resonant frequency cavity (630) establishing a first resonant frequency, and a back side resonant frequency cavity (632) acoustically matched with the front side resonant frequency cavity. Some embodiments provide wireless communication devices (120) having wireless communication circuitry to receive wireless communication, a front side ear cup (240) and a back side ear cup (140) for emitting substantially the same acoustical signals corresponding to received wireless communication. The wireless device can include a display portion (122) having the ear cups, a keypad portion (124), and a swivel connection (320) between the display and keypad portions.

### FIELD OF THE INVENTION

The present invention relates generally to audio ear cups, and more particularly to audio ear cups on wireless communication devices.

### BACKGROUND OF THE INVENTION

The number of wireless phone users has grown dramatically over the last decade. With this growth, the available features and functionalities have similarly grown in attempts to attract consumers to purchase certain phones, and/or select a certain wireless service provider. For example, many wireless phones include digital cameras, allow text messaging communication, allow access to the Internet, and numerous other features and functionality.

The types and designs of phones have similarly increased. For example, some phones are extremely small in size. Other phones provide a user with a larger display. Some phones open or flip in an attempt to provide a larger display while still providing a relatively small phone when flipped closed. Additionally, some wireless phones include a swivel display portion.

A swivel-flip wireless phone opens (sometimes referred to as a “clam” phone) and can allow a display to be swiveled relative to the keypad portion of the phone to allow a user to orient the display in a desired position. For example, the display can be swiveled 180 degrees then closed with the display now facing out and visible to the user. These types of phone typically require the swiveled portion to be in a predefined position in order for the user to answer and/or hear from the phone.

### BRIEF DESCRIPTION OF THE DRAWINGS

FIGS. 1-5 are perspective views of a swivel-flip type wireless phone in different configurations;

FIG. 6 is a sectioned perspective view of a dual sided ear cup acoustic system;

FIG. 7 is an exploded perspective view of the front side of the dual sided ear cup system of FIG. 6;

FIG. 8 is an exploded perspective view of the back side of the dual sided ear cup system of FIG. 6;

FIG. 9 is a simplified cross-sectional block diagram of a transducer assembly that is employed in the double sided ear cup system of FIG. 6;

FIG. 10 is a simplified elevation view of the back side of the transducer assembly of FIG. 6;

FIG. 11 is a perspective, exploded view of the transducer assembly of FIGS. 9 and 10 showing a flex, a support member and a gasket for cooperating with the transducer;

FIG. 12 is a perspective view of the transducer assembly of FIG. 11 showing the flexible circuit board, flex extension portion, and support member assembled together;

FIG. 13 is a simplified cross-sectional block diagram of a dual ear cup system; and

FIG. 14 is a simplified graphical representation of a low audio output response generated from a dual ear cup system for a standard Global System for Mobile Communications (GSM) mask.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENTS

The present embodiments provide a dual sided ear cup system for use with communication devices, such as wireless phones, to generate audio output from both a front side and back side of the communication device. The dual sided ear cup system is further configured so that the audio output is substantially equivalent from both the front side and the back side while still achieving high levels of quality and meeting industry standards.

One example of an implementation for the dual sided ear cup system is a swivel-flip wireless phone that allows the display portion to be swiveled. Typically, these phones only include a single ear cup on the display side of these types of phones. Because of the single ear cup, a user often has to swivel the display portion in order listen and/or to answer an incoming call or make an outgoing call. If the phone is positioned with the display exposed and closed, the user typically has to open the flip phone, and re-swivel the display portion to the original position in order to answer an incoming call or make an outgoing call. This required reorienting of the swivel portion of the phone undesirably limits the use of the phone and limits a user's ability to quickly answer the phone.

The dual sided ear cup systems of the present embodiments can be employed, as one example, in these types of swivel phones. By incorporating the dual sided ear cup system a user can listen and/or answer the phone from either side of the display portion regardless whether the display is facing the user or facing away from the user.

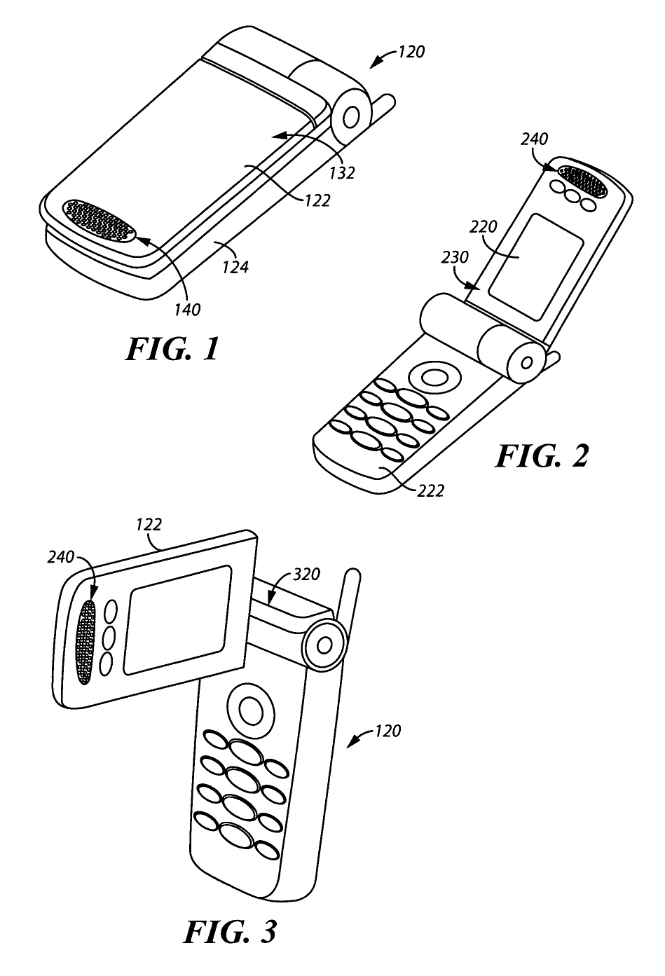

FIGS. 1-5 depict perspective views of a “clam” or flip type wireless phone 120 that further incorporates a swivel ear cup/display portion 122, and circuitry (not shown) to provide wireless communication and other functionality commonly available with wireless phones (e.g., camera, Internet access, games, calendar, and other such functionality). The flip phone 120 includes the display portion 122 and a key pad portion 124, where the display portion further includes a display 220 (see FIG. 2), and the key pad portion further includes a plurality of keys or buttons 222 (see FIG. 2). FIG. 1 shows the flip phone in a closed position with an exterior side or surface 132 of the display portion 122 being exposed and including an exterior or back side ear cup 140 from which low power audio output can be received as described fully below. FIG. 2 shows the flip phone of FIG. 1 in an open position with the display 220 visible and providing access to an interior or front side ear cup 240, and to the keys 222 of the key pad portion 124.

Some of these flip phones further allow for the display portion 122 to rotate or swivel allowing the user to change the orientation of the display portion relative to the key pad portion 124. FIG. 3 shows the flip phone 120 of FIGS. 1 and 2 in an open position with the display portion 122 rotated about a joint or swivel point 320. A user might rotation the swivel into this position, 90 degrees from the position shown in FIG. 2, when the user is preparing to take a picture allowing better viewing of the display showing the picture to be taken. Typically, swivel phones allow the user to completely rotate the display portion 122 and again close the phone with the display 220 exposed for viewing while the phone is closed. FIG. 4 depicts the phone 120 of FIGS. 1-3 in a closed position with the display portion 122 swiveled 180 degrees relative to the position of FIG. 1 to expose the display 220. FIG. 5 further shows the phone 120 in an open position with the display swiveled 180 degrees relative to the positioning of the display portion in FIG. 2, with the exterior surface 132 and back side ear cup 140 facing the key pad portion.

The dual sided ear cup system allows a user to utilize the phone and listen to audio output from either side of the display portion 122. Referring to FIGS. 2 and 5, an interior or display side or surface 230 of the display portion 122 includes the interior or front side ear cup 240, and the exterior side 132 of the display portion 122 includes the exterior or back side ear cup 140. Sound or acoustical output is emitted from both the front side ear cup 140 and the back side ear cup 142 allowing a user to answer and/or listen to the phone regardless of the swivel positioning of the display portion (i.e., with the display 220 facing the user when open (FIG. 2), or with the exterior side 132 facing the user when open (FIG. 5)).

The wireless phone industry defines industry standards and specifications that a phone is to meet for the maximum sound or audio levels emitted from ear cups. These specifications and/or standards are different than those for loud speakers that may be incorporated into wireless phones and generally not to be used directly adjacent a user's ear. The ear cups for wireless phones are generally designed for low power and low audio applications to avoid injury to a user's ear. Further, because of the low power, the acoustical effects generally have a significant impact on the resulting output signal audible to the user. The dual ear cup systems provide acoustical output that meets defined specifications and/or standards for both the front side and back side ear cups 140, 240. Further, preferably the system provides substantially the same acoustical output from both the front side ear cup 140 and back side ear cup 240.

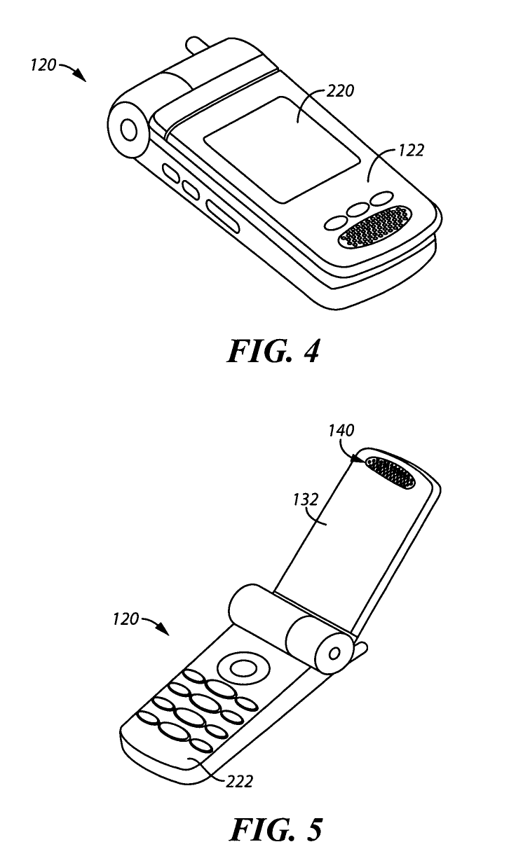

FIG. 6 is a cross-section view of a dual sided ear cup acoustic system 620 according to some embodiments. The dual sided ear cup system 620 is described as being incorporated into a wireless phone, however, the system 620 can be implemented in numerous other devices where it would be beneficial and/or desirable to emit sound in opposing directions, such as wireless walkie-talkies, computers, consumer electronic devices (e.g., personal digital video disc (DVD) players, personal compact disc (CD) player), and other such devices.

The dual sided ear cup system 620 includes a transducer 622 (which is commonly also referred to as a receiver and/or speaker). The transducer 622 has a front side 624 and back side 626. Various acoustical elements are provided for cooperating with the transducer 622 including front and back side resonant endocavities 630, 632, front and back side diffusion cavities 634, 636, and front and back side ectocavities 640, 642 formed in part by front and back side device ear cups 644, 646 that cooperate with a human ear concha (not shown). The front and back side endocavities are defined in part by front and back side endocavity volumes 650, 652 that each include an endocavity port 654, 656. The system 620 further includes a back side gasket 670, and an electrically conductive back side flex or flex member 672.

The device ear cups 644, 646 are defined in part by surfaces of the front and back side communication device enclosure or casing 660, 662, and resistive meshes or protective screens 664, 668. The front and back side diffusion cavities 634, 636 are defined at least in part by the meshes 664, 668 and the volumes 650, 652.

The transducer 622 is activated and/or driven by electrical circuitry of the wireless phone to generate acoustical signals and/or emissions from both the front and back sides 624, 626. In some implementations, the acoustical signals are generated from both the front and back sides simultaneously. The transducer 622 cooperates with matched front and back side acoustic elements to generate the desired acoustical output on both the front and back sides of the system 620. The match of acoustical elements provides output from the front side that is substantially identical to the output from the back side so that a user receives the same quality sound from both the front side and/or the back side of a device employing the dual sided ear cup system 620.

The front and back endocavities 630, 632 establish resonant frequency cavities and are acoustically matched forming acoustic resonators (e.g., Helmhotz resonators), where the front and back side resonant frequencies of the matched endocavities are substantially the same value. The acoustical matching does not necessarily mean that the physical dimensions or configurations of the front and back side endocavities cavities are equal or the same, but instead such dimensions and/or configurations are such that the cavities 630, 632 are acoustically matched. Similarly, acoustical matching does not necessarily mean that the components of the endocavities (e.g., endocavity volumes 650, 652, ports 654, 656, etc.) are equal in size or shape. The matching is achieved by setting the front and rear resonant frequencies to be substantially the same with the acoustic loading substantially the same for the front and back sides. The resonant frequencies for the front and back sides are matched by adjusting the components of the endocavities. For example, the physical dimensions and/or cubic dimensions or configurations of one or both endocavity volumes 650, 652 can be adjusted to alter or control the resonant frequency of the respective endocavities. Additionally and/or alternatively, the size and shape of the endocavity ports 654, 656 can be adjusted to effect resonant frequency and/or loading.

In some implementations, the front and back endocavity volumes 650, 652 are acoustically matched when the front and back side endocavity volumes have substantially equal cubic dimensions or configurations. The actual physical dimensions (e.g., length, width, depth), however, are not necessarily equal. The front and back side endocavity ports 654 and 656, respectively, are similarly matched to achieve the desired substantially equivalent acoustical output. Again, the sizes of the ports 654, 656 are not necessarily equal. The acoustical effects and/or loading on the transducer are matched in part through the matching of the port sizes.

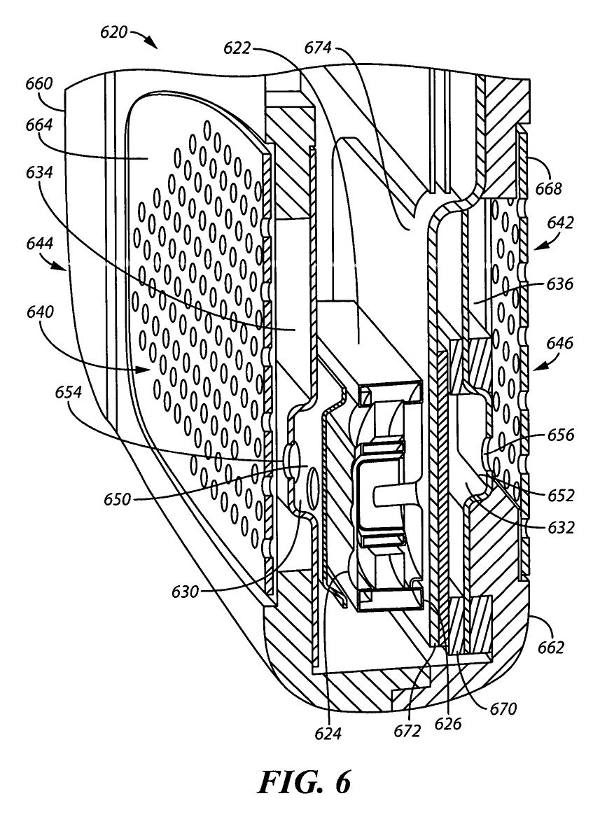

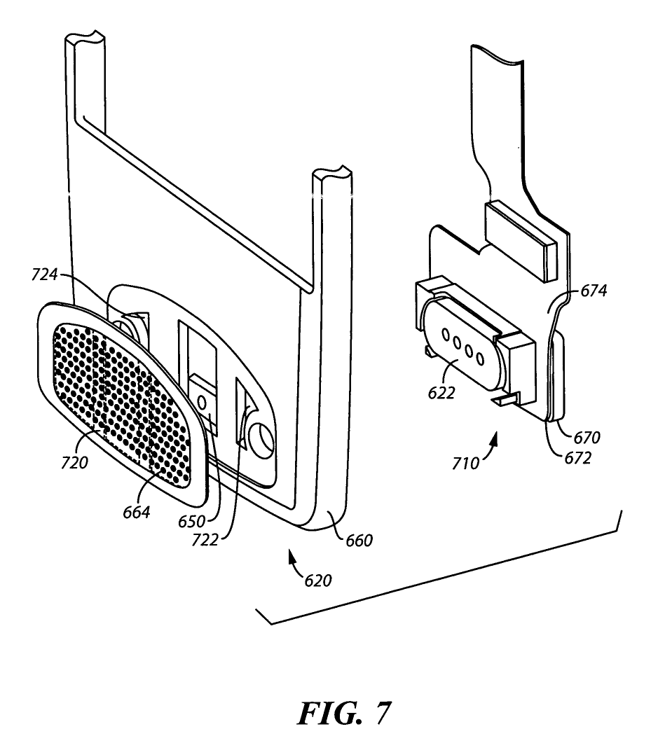

FIG. 7 depicts an exploded perspective view of the front side of the dual sided ear cup system 620 showing the front side casing 660 with the front side endocavity volume 650 mounted to the casing, the front side mesh 664 to be mounted onto the casing 660, and a transducer assembly 710 (comprising in part the transducer 622, gasket 670, flex 672, circuit board 674, and other components as more fully described below) to be positioned adjacent to the front side endocavity volume 650. FIG. 8 is an exploded perspective view of the back side of the dual sided ear cup system 620 showing the back side casing 662 with the back side endocavity volume 652 mounted to the casing, the back side mesh 664 to be mounted onto the casing 662, and the positioning of the transducer assembly 710 relative to the back side casing proximate the back side endocavity volume 652. Referring to FIGS. 7 and 8, the front and back side endocavity volumes 650, 652 are formed (e.g., pressed) as a recess in a sheet 820 of metal, plastic, or other relevant material or combinations of materials with the desired physical dimensions. The endocavity volumes 650, 652 can take on substantially any shape and/or size that achieves the desired acoustical output and/or to establish desired loading on the front and back sides of the transducer 622, respectively. Adjustments to the dimensions and configurations of the endocavity volumes cause adjustments in the resonant frequency of the endocavities as more fully described below.

The sheet 820 can be substantially any shape, and in some implementation, the shape of the sheet is dictated by the configuration of the front and/or back casing 660, 662 to allow secure positioning and mounting of the sheet 820 thereto, and thus the endocavity volume within the system 620. As indicated above, the endocavity volumes 650, 652 can be formed in the sheet through various means, such as being pressed in a sheet of metal, formed through injection molding, and other such processes. The sheet is secured with the casing through relevant methods, such as compression fit, adhesive, slot and groove, and other relevant methods and combinations of methods.

The front and back side endocavity ports 654, 656 are further shown as formed in the endocavity volumes 650, 652. The ports can have substantially any shape and/or size to achieve the desired acoustical output and/or to establish desired loading on the front and back sides of the transducer 622, respectively.

The dual sided ear cup system 620 further includes and/or electrically couples with circuitry 840 that drives the transducer 622. In some implementations the circuitry is a single equalizer 840 that is electrically coupled with the circuit board 674 that in turn electrically communicates electrical signals to the transducer 622. The equalizer can be implemented as software, hardware, or a combination of software and hardware. Based on the acoustical design of the dual ear cup system herein, a single equalizer can provide accurate adjustment of the drive signals to maintain the output signals from both the front side and back side ear cups to within a desired specification and/or mask as fully described below.

In some alternative embodiments, however, the system employs two or more equalizers that provide separate signals to the transducer depending on the orientation of the device within which the dual ear cup system is employed. For example with the dual ear cup system employed with a wireless phone 120 (see FIG. 3) having a swivel display portion 122, circuitry of the wireless phone includes a sensor that detects the orientation of the display portion through mechanical contact, Infrared, magnet hall effect, or other relevant detecting methods of determining orientation. Based on the detected orientation, the wireless phone circuitry selects one of the two equalizers to drive the transducer 620. The dual equalizers provide an enhanced drive signal to the transducer to further enhance the transducer's acoustic frequency response presented to human ear concha depending on orientation.

As indicated above, however, the matching of acoustical elements of the dual sided ear cup system 620 allows it to be implemented with a single equalizer to drive the transducer regardless of orientation of the swivel phone while still generating substantially the same acoustical output signal within a tolerance from the front and back side ear cups 644, 646. Further, because the same acoustical output signal is emitted from both the front and back side cups 644, 646, the system 620 does not need to generate different drive signals to the transducer depending on whether the user is listening from the front side or the back side (e.g., based on an orientation of the device). This simplifies the drive electronics of the wireless communication device employing the dual sided ear cup system. Further, the wireless communication device does not need to include a detector to determine the positioning of the swivel display portion of the device, nor does the wireless communication device need to include additional programming and/or hardware to select one of two equalizers.

Referring to FIGS. 6, 7 and 8, the diffusion cavities 634, 636 are defined at least in part between the endocavity volumes 650, 652 and the meshes 664, 668. The diffusion cavities are designed to provide a diffuse acoustic field of sound to form a relatively large area of substantially equal loudness. The resistive meshes or protective screens 664, 668 include and/or are supported by grills or supports 720, 830 that add structural stability and strength. The supports generally include ribbing that extends across the mesh to support and strengthen the mesh. The mesh is secured with the casings 660, 662 through adhesive, a snap fit, and other such methods. In some implementations, the front and backside meshes have an identical size and configuration providing identical acoustical effects and reducing manufacturing cost and complexity.

Additionally, the front and back side grills 720, 830 and/or meshes 664, 668 are further configured with aperture sizes and shapes, aperture patterns, and grill to endocavity port separations, where the aperture patterns, aperture sizes, and/or grill to endocavity port separations are optimized to provide proper linear loudness over the transducer electrical drive level range. The mesh and/or grill apertures can be of substantially any relevant size, shape and/or pattern allowing sound to pass through at desired levels. Further, the pattern, size and shape are further selected based on aesthetics, while providing protection to the dual sided ear cup system 620 without adversely affect the desired frequency response. In some embodiments, size, shape and patterns of the apertures are identified, and simulations are performed to determine acoustical effects with adjustments to the size, shape and/or patterns being made to achieve desired effects.

The front and/or back side diffusion cavities 634, 636 further include one or more ectocavity leak ports or passageways 722, 724, and 822, 824, respectively. The ectocavity leak ports allow the dual sided ear cup system 620 to meet leak tolerance designs and to adjust the resonant frequency of the ectocavity 640, 642. The leak ports are optimized to reduce the loudness differences from variations of coupling to the human ear. For example, leak ports 722, 724, 822, 824 in some implementations avoid a significantly tight seal with the user's ear to avoid excessively loud sounds into the ear and thus meeting leak tolerances. The combination of the endocavity and ectocavity resonant frequencies provides desired acoustic frequency response enhancements. The size, positioning and shape of the leak ports are similarly determined based on simulations followed by iterative testing.

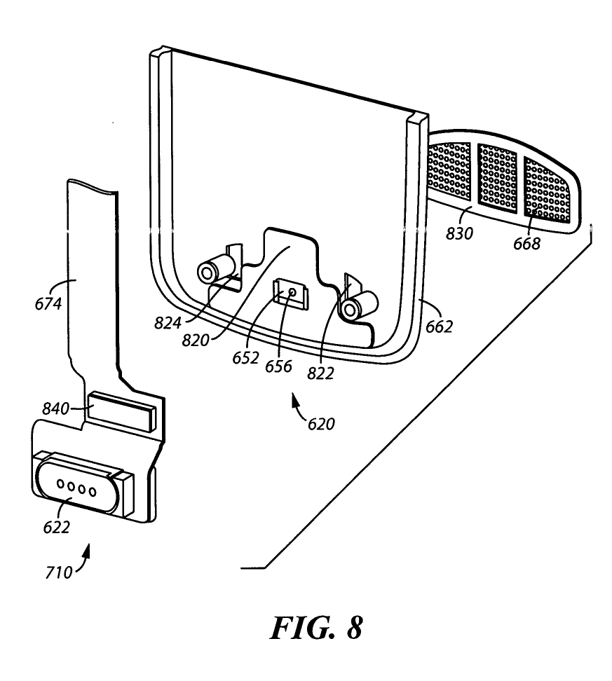

FIG. 9 depicts a simplified cross-sectional block diagram of the transducer assembly 710 according to some embodiments that is employed in the double sided ear cup system 620. The assembly 710 includes the transducer 622, a front side seal 922, a back side flex 672, and a back side gasket 670. The front side seal 922 is secured with the transducer and substantially minimizes and preferably completely avoids leaks from the front side endocavity 640. In some embodiments, the seal 922 includes double sided adhesive, where adhesive is on both sides of at least a perimeter of the seal, i.e., adhesive on a back side of the seal that secures with the transducer, and adhesive on the front side of the seal that secures with the front side casing 660 and/or volume 650. Further, the adhesive on the back side of the seal avoids leaks from between the transducer and the seal, and similarly the adhesive on the front side of the seal avoids leaks from between the seal and the casing. The double sided adhesive seal additionally compensates, at least in part, for some of the sensitivity of the acoustical resonator design to cavity leakage. The front side seal can be constructed of a material, such as urethanes (e.g., such as Poron® urethanes from the Rogers Corporation of Rogers, Conn.), polyester (e.g., Mylar® of DuPont Teijin Films of Hopewell, Va.), plastic, or other relevant material, and in some implementations is substantially non-compressible. By utilizing a non-compressible seal, the positioning of the transducer 622 is precisely maintained relative to the casing, and thus, the size and configuration of the front side endocavity 640 is similarly maintained to further ensure a substantially constant resonant frequency.

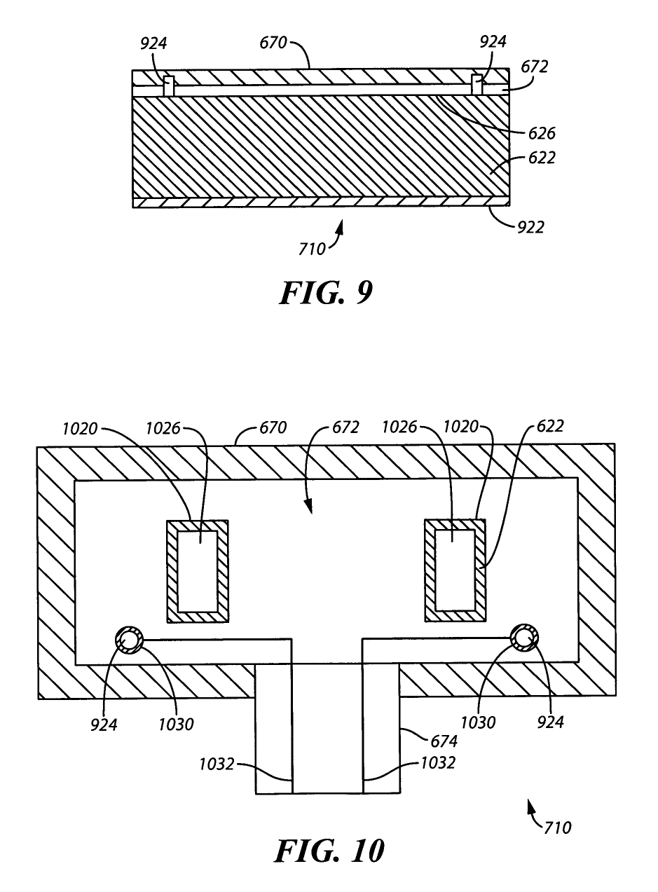

Still referring to FIG. 9, a flex 672 cooperates with the back side 626 of the transducer 622, and is coupled with and/or extends integrally from a circuit board 674 (see FIGS. 6 and 7) that is itself also preferably resiliently flexible like the flex extension portion 672 thereof and includes and/or couples with electrical circuitry and one or more drivers or equalizers (not shown) that supply electrical signals to drive the transducer. The flex is at least partially conductive to electrically conduct drive signals to the transducer 622. Typically, the transducer includes electrical contacts 924, such as pin contacts, solder posts, electrical pads, or other such contacts. The flex 672 further extends over and/or includes an extended portion that extend from the electrical contacts to cover at least portions of the back side 626 of the transducer 622, and in some implementations surrounds a perimeter of the back side 626 of the transducer 622 to establish a seal and/or to avoid leakage of the acoustical signal emitted from the one or more vents 1026 (see FIG. 10) of the back side 626 of the transducer 622.

FIG. 10 depicts a simplified elevation view of the back side of the transducer assembly 710. Referring to FIGS. 9 and 10, the flex 672 further includes vent apertures or openings 1020 that correspond to one or more vents 1026 of the transducer from which sound is emitted. The vent openings 1020 avoid interfering with the acoustical output, while still overlaying a desired portion of the back side of the transducer 622. The vent openings 1020 are sized to be sufficiently larger than the corresponding transducer vents 1026 so that there is a threshold distance or spacing from the vents 1026 of the transducer to avoid interference or distortions with the output, and to further avoid vibrations and/or fluctuations of the flex 672 proximate the vents 1026.

Typically, devices that employ transducers are not concerned with the back side of the transducer and acoustical output from the back side. Additionally, because of the lack of concern about the back side of the transducer, electrical contact is simply made to the transducer without concern with whether the wiring or leads to the transducer would interfere with back side acoustics.

The dual sided ear cup system 620, however, utilize the acoustical output from the back side of the transducer, and thus in some embodiments the flex 672 is operable at least in part to establish a seal about the perimeter of the transducer and further deliver electrical drive signals to the transducer while avoiding interfering with and instead enhancing the acoustical output from the back side 626 of the transducer 622 by, at least in part, avoiding acoustic leaks. By overlaying portions of the transducer, the flex does not interfere with acoustical output, and further establishes a seal in same implementation about the back side of the transducer.

The flex 672 also has electrical contact apertures 1030 through which the solder posts 924 extend. The contact apertures 1030 further include conductive material that contact the solder posts 924 to establish electrical contact between the flex 672 and the transducer. The electrical contact is maintained through soldering, spring contacts, conductive spray, elastomer, and other such relevant methods. For example, the perimeters of the contact apertures are coated with gold, or other conductive material to enhance the electrical connection. Electrical leads or traces 1032 formed on the flex portion 672 extend from contact apertures 1030 to the flexible circuit board 674 to couple with one or more equalizers and/or drivers (not shown). The flex 672 is secured with the transducer through the electrical coupling with the electrical contacts (e.g., solder posts 924) of the transducer. The flex can further be secured, for example with adhesive or other relevant methods. In some implementations, the flex is additionally and/or alternatively sealed through compression of the gasket 670 against the flex as described fully below.

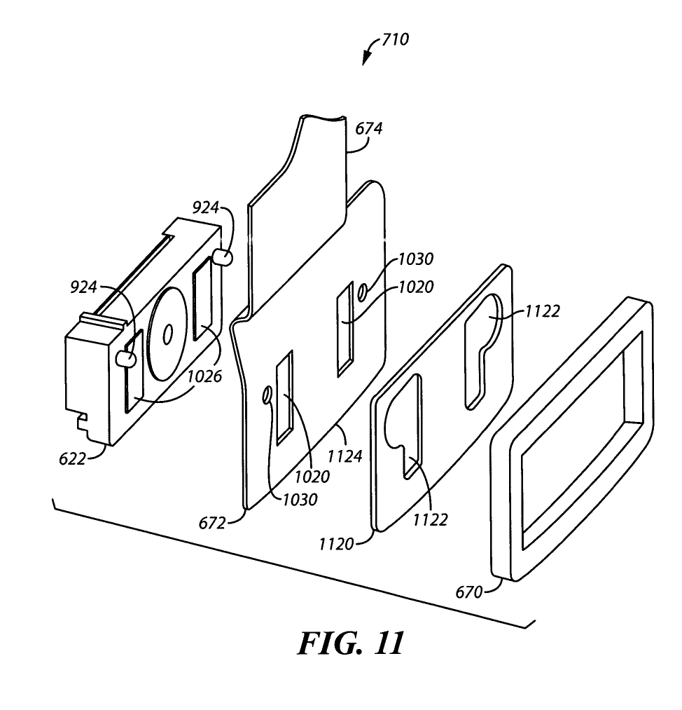

FIG. 11 depicts a perspective, exploded view of a transducer assembly 710 with the transducer 622 being assembled with a flex 672, a support member 1120 and a gasket 670. As introduced above, the flex 672 overlays at least a portion of the back side of the transducer, and in some implementations the flex has a configuration that generally matches or mirrors the shape of the back side 626 of the transducer 622, to include an extended perimeter or circumferential portion 1124 that corresponds to the perimeter of the transducer 622. The mirroring provides a seal that aids in substantially avoiding acoustical leaks. The vent openings 1020 and contact apertures 1030 are further shown and correspond to the vents 1026 and solder posts 924 of the transducer 622, respectively. As mentioned, the flex 672 can extend integrally from the circuit board 674, which can be a flexible circuit board to resist damage to the circuit board, flex extension portion 672, gasket 670, and/or transducer 622 due to impacts and or jarring of the device within which the dual sided ear cup system 620 is employed. The flex 672 can be constructed of polyester (e.g., Mylar®) with traces of copper for electrical conductivity, urethanes (e.g., such as Poron® urethanes from the Rogers Corporation of Rogers, Conn.) with conductive material, plastic, and other relevant materials or combinations of materials. Additionally and/or alternatively, a thin conductive shield (e.g., silver or silver paint sprayed over the material) or other conductive material can be sprayed or applied to at least portions of the flex 672.

Some embodiments further utilize a support member 1120 to provide added support to the flex 672 and/or further maintain positioning of the flex relative to the transducer 622. The support member additionally includes openings 1122 that substantially correspond to the vents 1026 of the transducer. The openings 1122 are also sized to allow the solder posts 924 adjacent to the transducer vents 1026 to extend therethrough, or additional solder post holes can be included. The support member 1120 can be configured and formed of a relevant material so that it is more rigid than the flex to provide the desired structural support, such as sheet metal, plastic, and other relevant material or combinations of materials.

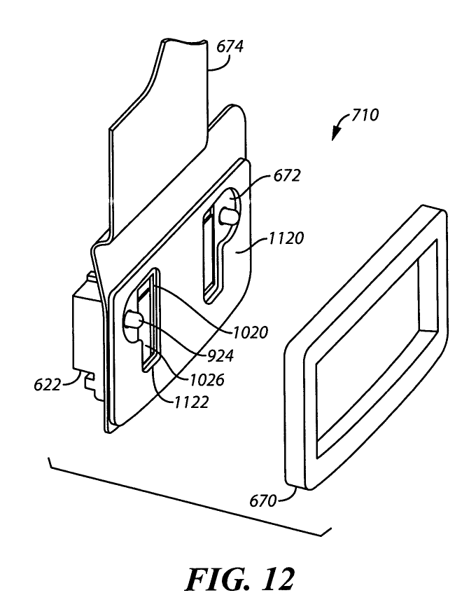

FIG. 12 depicts a perspective view of the transducer assembly 710 with the flexible circuit board 674, flex 672 and support 1120 assembled to the transducer 622, where the vent openings 1020, contact apertures 1030, and the openings 1122 of the support member 1120 are aligned with the vents 1026 of the transducer. The gasket 670 is further shown in alignment with the flex 672 and transducer 622 prior to placement.

Referring to FIGS. 9-12, the transducer assembly 710 further includes the back side gasket 670. The gasket 670 extends around the perimeter of the transducer 622. In some implementations, the gasket 670 compensates for structural inconsistencies and/or stack-up tolerances, as well as establishes and/or helps in maintain a seal about the back side of the transducer 622. To compensate for structural and/or surface inconsistencies and/or stack-up tolerances between the components of the transducer assembly 710, the gasket is preferably constructed of a compressible material, such as urethanes (e.g., such as Poron® urethanes), foam, rubber, silicon, plastic or other relevant compressible material. For example, the gasket 670 can be formed of a closed cell compressible urethane or foam. The closed cells substantially avoid sound leakage through the gasket. The gasket 670 can alternatively be formed from an open celled foam, such that when the gasket is compressed the open cells close to prevent or at least minimize sound leakage.

As introduced above, the gasket can be configured to absorb surface irregularities of the rear transducer to establish a flush and/or secure fitting of components with the transducer 622. By employing a compressible gasket, the gasket further provides and/or absorbs component stack-up tolerance variations. Because the dual sided ear cup system 620 is implemented into devices, such as wireless phones which often desirably have minimal thicknesses, the stack-up of components (e.g., front and rear diffusion cavities 634, 636, front and rear endocavity volumes 650, 652, front and rear endocavities 630, 632, transducer 622, etc.) typically have a predefined maximum total thickness with only minimal tolerance for variation. Additionally, the thicknesses of the components and the cooperation between components often have minor variations. As such, the tolerance of the stack up can be difficult to achieve. By employing the compressible gasket 670, the gasket allows for variations in the components of the system 620 and compensates for those variations through compression and expansion of the gasket.

The gasket 670 and flex 672 additionally provides part of a transducer rear seal/gasket solution. To ensure proper rear seal and gasket functionality, the flex 672 includes the extended circumferential portion 1124 that corresponds to the perimeter of the transducer 622. Similarly, the gasket 674 matches or mirrors the perimeter of the transducer 622 and the circumferential portion 1124 of the flex 672. The flex 672 and the gasket 670 cooperate to seal with the transducer to avoid sound pressure leaks that can alter the resonant frequency of the back side endocavity 632 and thus the acoustical output. Further, the gasket and flex are configured to establish a desired final thickness to within defined tolerances so that the system maintains a desired back side resonant frequency.

In some embodiments, the cooperation between the front side seal 922 and the back side gasket 670 and flex 672 is such that one of the front side or the back side is non-compressible to precisely control at least one of the resonant frequencies of the front side and/or back side endocavities 630, 632. For example, the front side seal 922 can be generally non-compressible to precisely fix the positioning of the transducer 622. This provides for precisely defined front and back side endocavity resonant frequencies and thus acoustical outputs.

The gasket 670 of FIGS. 11 and 12 is shown generally to have a shape similar to that of the perimeter of the transducer 622. The shape of the gasket, however, can be other shapes while still achieving the desired sealing, irregularity compensation and/or stack-up compensation. For example, the gasket can additionally include side extensions that extend beyond the perimeter of the back side 626 of the transducer to extend along and encase at least a portion of the sides of the transducer.

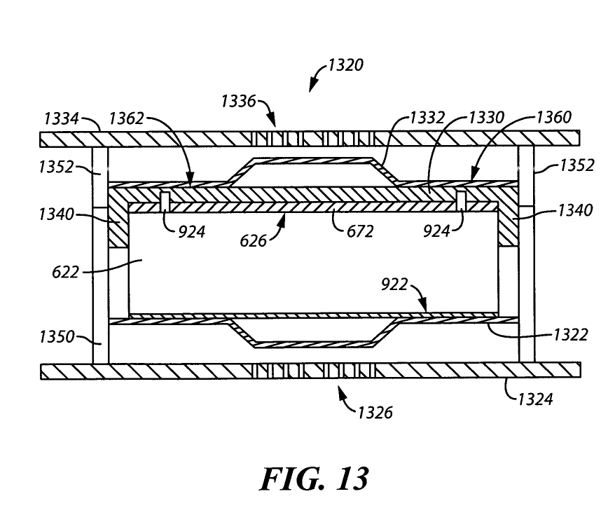

FIG. 13 depicts a simplified cross-sectional block diagram of the dual ear cup system 1320 according to some embodiments. The system 1320 includes a transducer 622 with solder posts or pins 924, front side seal 922, front side endocavity volume 1322, front side casing 1324 with mesh 1326, back side flex 672, a cup shaped or boot gasket 1330, a back side endocavity volume 1332, and a back side casing 1334 with mesh 1336. The gasket 1330 includes extended sides 1340 that extend below the back side surface 626 of the transducer 622. At least one of the front and back side casings 1324, 1334 further include extensions 1350, 1352 that extend from the casing to fit adjacent the transducer and extended sides 1340 of the gasket 1330. The casing extensions 1350 press against the extended sides 1340 of the gasket 1330 to at least partially compress the extended sides against the transducer 622. Additionally, the sheet 1360 within which the back side volume 1332 is formed is pressed against the back side surface 1362 of the gasket 1330 compressing the gasket and further enhancing a seal about the transducer 622. Typically, the flex 672 cooperates with the gasket to further seal about the perimeter of the back side of the transducer, and further electrically couples with the solder posts 924.

The dual sided ear cup systems of the present embodiments achieve precisely controlled acoustical outputs. As introduced above, the wireless phone industry defines industry standards and specifications defining sound quality and/or the maximum sound or audio levels emitted from ear cups. These standards are different than those for loud speakers that generally operate at higher power levels with louder audio output. Typically, ear cups are low power, low audio applications. The acoustical elements of each ear cup 644, 645 of the dual sided ear cup system 620 are configured such that the acoustical output from both front and back side ear cups 644, 646 meet desired acoustical specifications or masks.

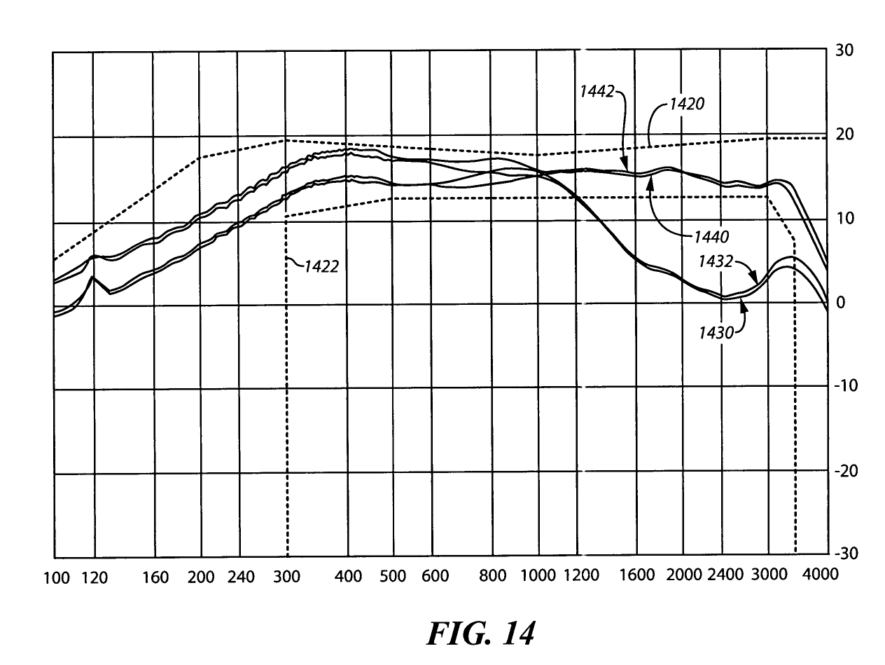

FIG. 14 depicts a simplified graphical representation of a low audio output response generated from a dual ear cup system according to some embodiments for a standard Global System for Mobile Communications (GSM) mask. Dashed lines 1420 and 1422 define a desired low audio GSM mask envelope within which the acoustical output from both the front and back side acoustical output signals are desirably maintained. The lines labeled 1430 and 1432 represent front and back side acoustical outputs, respectively, emitted from a dual ear cup system without the use of an equalizer to further condition the signals driving the transducer, and thud affected simply by the matching acoustic elements of the system. It can be seen based on these two lines 1430, 1432 that the matched system provide substantially the same acoustical output while both outputs are maintained within the desired envelope for a substantial portion of the tested frequency range, and begin to deviate from the envelope at frequencies of between about 1200 Hz to about 3500 Hz. The remaining two lines 1440, 1442 represent front and back side acoustical outputs, respectively, emitted from a matched dual ear cup system of the present embodiments, with the use of a single equalizer to further condition the signals driving the transducer. By providing equalizer adjustments to the signals driving the transducer in cooperation with the matched front and back side acoustic elements of the system, the outputs from the front and back side ear cups are substantially identical and both are maintained within the mask envelope. Therefore, the matched dual sided ear cup system provides precise acoustical output signals to a user from both the front side and back side ear cups. As indicated above, some embodiments employ multiple equalizers and the addition equalizer(s) allows further control of the signals to more precisely mirror front and back side outputs and/or allow precision adjustments to the signals to further control the outputs relative to the desired envelope.

The dual sided ear cup systems and/or apparatuses provide acoustically matched outputs from both sides of a device, such as a wireless phone. Further, the dual sided ear cup system achieves substantially the same quality signal from both ear cups, such that the output meets set standards. The systems can be employed in substantially any device where it would be beneficial to emit low power acoustical signals from both sides of the device. Additionally, the system can be implemented with only a single equalizer while still achieving the desired matched outputs from both ear cups.

While the invention herein disclosed has been described by means of specific embodiments and applications thereof, numerous modifications and variations could be made thereto by those skilled in the art without departing from the scope of the invention set forth in the claims.

What is claimed is:

1. A dual sided ear cup system operable with a communication device, the dual sided ear cup comprising:
a transducer having a front side and a back side for generating acoustical output from both the front side and the back side;
a front side resonant frequency cavity configured to establish a first resonant frequency; and
a back side resonant frequency cavity that is acoustically matched with the front side resonant frequency cavity to establish a second resonant frequency that is substantially equal to the first resonant frequency.

2. The dual sided ear cup of claim 1, further comprising:
an electrically conductive member that electrically couples with the transducer and partially seals with the back side of the transducer.

3. The dual sided ear cup of claim 2, wherein the electrically conductive member extends about a perimeter of the back side of the transducer and seals about the perimeter of the back side of the transducer.

4. The dual sided ear cup of claim 1, wherein the front side resonant frequency cavity comprises a front side resonant frequency control member; and
the back side resonant frequency cavity comprises a back side resonant frequency control member that is acoustically matched to the front side resonant frequency control member.

5. The dual sided ear cup of claim 4, wherein the front side resonant frequency control member includes a front port; and
the back side resonant frequency control member includes a back port with the back port being acoustically matched with the front port.

6. The dual sided ear cup of claim 5, wherein the front port is configured to establish a front loading on the transducer; and
the back port is configured to establish a back loading on the transducer that is substantially equivalent to the front loading.

7. The dual sided ear cup of claim 4, wherein the front side resonant cavity control member has first predetermined configuration and the back side resonant cavity control member has a second predetermined configuration that is not equal to the first predetermined configuration.

8. A dual sided ear cup operable with a communication device, the ear cup comprising:
a transducer having a first side and a second side;
a first side seal configured to be sealed about at least a portion of the first side of the transducer; and
an electrically conductive flex that is configured to electrically couple with the transducer and includes an extended portion that extends over portions of the second side of the transducer.

9. The dual sided ear cup of claim 8, wherein the extended portion of the conductive flex extends to substantially mirror a perimeter of the second side of the transducer.

10. The dual sided ear cup of claim 9, wherein the transducer second side includes vents and the flex has vent openings that correspond to the transducer second side vents.

11. The dual side ear cup of claim 8, further comprising:
a second side gasket fixed about a perimeter of the transducer and establishing a seal about the second side of the transducer.

12. The dual side ear cup of claim 11, wherein the second side gasket is of compressible material to compensate for stack-up variations between the transducer, the flex and the second side gasket.

13. The dual side ear cup of claim 8, further comprising:
a first side endocavity volume that acoustically cooperates with the first side of the transducer, and is configured to control a first resonant frequency; and
a second side endocavity volume that acoustically cooperates with the second side of the transducer, and is acoustically matched to the first side endocavity volume, and configured to control a second resonant frequency.

14. The dual side ear cup of claim 8, further comprising:
a first side diffusion cavity configured to provide a first diffuse acoustic field of sound; and
a second side diffusion cavity configured to provide a second diffuse acoustic field of sound that is acoustically matched with the first diffusion acoustic field of sound.

15. A wireless communication device, comprising:
wireless communication circuitry configured to receive wireless communication signals;
a front side ear cup for emitting acoustical signals corresponding to the received wireless communication signals; and
a back side ear cup for emitting substantially the same acoustical signals as emitted from the front side ear cup.

16. The wireless communication device of claim 15, further comprising:
an ear cup/display portion including the ear cups and a keypad portion having keys for being operated by a user; and
a swivel connection between the ear cup/display and keypad portions to allow a user to orient either the front side ear cup or back side ear cup for hearing the acoustical signals emitted therefrom.

17. The wireless communication device of claim 15, wherein the front side ear cup is acoustically matched with the back side ear cup.

18. The wireless communication device of claim 15, including an ear cup/display portion having opposite front and back sides with the front side ear cup positioned at the front side of the ear cup portion, and the back side ear cup at the back side of the ear cup portion.

19. The wireless communication device of claim 15, including a single transducer that supplies the acoustical signals to both the front side ear cup and the back side ear cup.
